(19) United States
(12) Patent Application Publication
(10) Pub. No.: US 2010/0021754 A1
(43) Pub. Date: Jan. 28, 2010

(54) PREPARATION OF POLYMER DISPERSIONS IN THE PRESENCE OF INORGANIC POLYMER PARTICLES

(75) Inventors: Peter Schlichting, Bratislava (DE); Marc Schroeder, Canton, MI (US); Hermann Seyffer, Heidelberg (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/518,110

(22) PCT Filed: Dec. 11, 2007
(86) PCT No.: PCT/EP2007/063678

§ 371 Date: Jun. 8, 2009

(30) Foreign Application Priority Data
Dec. 15, 2006 (EP) 06126272.1

(51) Int. Cl. B32B 27/10; C08L 33/18; C08L 27/00; C08L 33/04; C08L 25/00; C08L 29/00; C08F 2/44

(52) U.S. Cl. 428/512; 524/850; 524/851; 524/853; 524/855; 524/849; 524/856; 428/514

(57) ABSTRACT

Aqueous polymer dispersion obtainable by emulsion polymerization of monomers in the presence of inorganic polymer particles (inorganic particles for short) which are dispersible in the aqueous phase without surface-active assistants.

The invention relates to aqueous polymer dispersions which are obtainable by emulsion polymerization of monomers in the presence of inorganic polymer particles (inorganic particles for short) which are dispersible in the aqueous phase without surface-active assistants.

The invention also relates to the use of these aqueous polymer dispersions as binders in paper coating slips.

For many uses, in particular for paper coating slips, polymer dispersions which have as high a solids content as possible in combination with as low a viscosity as possible are desired.

In addition to binder and water, paper coating slips generally also comprise pigments and further assistants.

For simple and problem-free processing of the aqueous paper coating slip, it is desired that the paper coating slip as a whole has a low viscosity. A low viscosity also permits a higher solids content. Since less water has to be removed on drying, energy costs can also be reduced.

Furthermore, the performance characteristics of the coated paper, for example resistance to mechanical loads, in particular pick resistance, optical appearance, e.g. smoothness and gloss, and the printability, should be as good as possible.

WO 02/48459 discloses paper coating slips whose viscosity is reduced by adding highly crosslinked polyester amides.

EP-A 1 479 744 describes the addition of polymeric silicon compounds, for example of water-soluble alkali metal silicates, to contact adhesives in order to improve the adhesion.

The prior, non-prior-published European application 06 118 852.0 (PF 58232) describes paper coating slips which, in addition to emulsion polymer, comprise polysilicic acid dissolved or dispersed in water or dispersed silica.

An object of the present invention was polymer dispersions having as high a solids content and as low a viscosity as possible, and paper coating slips having a low viscosity and good performance characteristics.

Accordingly, the polymer dispersions defined above were found. Paper coating slips which comprise these polymer dispersions were also found.

The aqueous polymer dispersions according to the invention are obtainable by emulsion polymerization of monomers in the presence of inorganic polymer particles (inorganic particles for short) which are dispersible in the aqueous phase without surface-active assistants. The polymer formed from the monomers is therefore an emulsion polymer.

### Regarding the Composition of the Emulsion Polymer

The emulsion polymer preferably comprises at least 40% by weight, preferably at least 60% by weight, particularly preferably at least 80% by weight, of so-called main monomers.

The main monomers are selected from C₁-C₂₀-alkyl (meth)acrylates, vinyl esters of carboxylic acids comprising up to 20 carbon atoms, vinylaromatics having up to 20 carbon atoms, ethylenically unsaturated nitriles, vinyl halides, vinyl ethers of alcohols comprising 1 to 10 carbon atoms, aliphatic hydrocarbons having 2 to 8 carbon atoms and one or two double bonds or mixtures of these monomers.

For example, alkyl (meth)acrylates having a C₁-C₁₀-alkyl radical, such as methyl methacrylate, methyl acrylate, n-butyl acrylate, ethyl acrylate and 2-ethylhexyl acrylate, may be mentioned.

Mixtures of the alkyl (meth)acrylates are also particularly suitable.

Vinyl esters of carboxylic acids having 1 to 20 carbon atoms are, for example, vinyl laurate, vinyl stearate, vinyl propionate, vinyl versatate, and vinyl acetate.

Suitable vinylaromatic compounds are vinyltoluene, α- and p-methylstyrene, α-butylstyrene, 4-n-butylstyrene, 4-n-decylstyrene and preferably styrene. Examples of nitriles are acrylonitrile and methacrylonitrile.

The vinyl halides are ethylenically unsaturated compounds substituted by chlorine, fluorine or bromine, preferably vinyl chloride and vinylidene chloride.

For example, vinyl methyl ether or vinyl isobutyl ether may be mentioned as vinyl ethers. Vinyl ethers of alcohols comprising 1 to 4 carbon atoms are preferred.

Ethylene, propylene, butadiene, isoprene and chloroprene may be mentioned as hydrocarbons having 2 to 8 carbon atoms and one or two olefinic double bonds.

Preferred main monomers are C₁-C₁₀-alkyl (meth)acrylates and mixtures of the alkyl (meth)acrylates with vinylaromatics, in particular styrene (also referred to together as polyacrylate binder) or hydrocarbons having 2 double bonds, in particular butadiene, or mixtures of such hydrocarbons with vinylaromatics, in particular styrene (also referred to together as polybutadiene binder).

In the case of polybutadiene binders, the weight ratio of butadiene to vinylaromatic (in particular styrene) may be, for example, from 10:90 to 90:10, preferably from 20:80 to 80:20.

The emulsion polymer therefore preferably comprises at least 60% by weight of butadiene or mixtures of butadiene and styrene or at least 60% by weight of C₁- to C₂₀-alkyl (meth)acrylates or mixtures of C₁- to C₂₀-alkyl (meth)acrylates and styrene.

Polybutadiene binders are particularly preferred. The emulsion polymer therefore particularly preferably comprises at least 40% by weight, preferably at least 60% by weight, particularly preferably at least 80% by weight, in particular at least 90% by weight, of hydrocarbons having 2 double bonds, in particular butadiene, or mixtures of such hydrocarbons with vinylaromatics, in particular styrene.

In addition to the main monomers, the emulsion polymer may comprise further monomers, for example monomers having carboxyl, sulfo or phosphonic acid groups. Carboxyl groups are preferred. For example, acrylic acid, methacrylic acid, itaconic acid, maleic acid or fumaric acid and aconitic acid may be mentioned. In a preferred embodiment, the emulsion polymers have a content of ethylenically unsaturated acids of in particular from 0.05% by weight to 5% by weight.

Further monomers are, for example, also monomers comprising hydroxyl groups, in particular C₁-C₁₀-hydroxyalkyl (meth)acrylates, or amides such as (meth)acrylamide.

### Regarding the Inorganic Particles

The inorganic or organic polymer particles (inorganic particles for short) are those which are dispersible in the aqueous phase without surface-active assistants. Accordingly, preferably no surface-active assistants are used for dispersing the particles in water, but the concomitant use of such assistants is in principle possible.

They are in particular inorganic particles which can be dispersed in a stable manner in water owing to their content of hydrophilic groups, e.g. hydroxyl groups or primary amino groups, particularly preferably of hydroxyl groups. Hydrophilic groups are present for this purpose in particular on the surface of the (in)organic particles.

In particular, silica sols may be mentioned as inorganic particles.

Starting from silicic acid (Si(OH)₄), silicic acid chains (polysilicic acid) initially form by condensation and finally three-dimensional silica networks (silica particles) form by further condensation of the OH side groups too. The term silica sol is understood as meaning silica particles dispersed in water. On the surface, the silica particles carry hydroxyl groups which are not condensed for the formation of silica structures. These hydroxyl groups result in self-dispersibility of the silica particles; the concomitant use of other surface-active assistants is therefore not required.

The silica particles may be chemically modified; for example, some of the hydroxyl groups may have been reacted with other compounds, giving, for example, silica particles which, in addition to the hydroxyl groups, comprise other organic groups, e.g. primary amino groups. In another type of modification, foreign atoms, in particular metal atoms of main group III, e.g. boron or in particular aluminum, are incorporated into the silica lattice structure. A content of such foreign atoms, in particular on or in the vicinity of the surface of the silica particles, may be advantageous.

The silica particles may comprise further constituents (see above) or impurities, for example due to other minerals.

The content of such constituents or impurities is in general less than 10% by weight, particularly preferably less than 5 or less than 3% by weight, in particular less than 1% by weight based on the silica particles.

Suitable silica sols are obtainable, for example, from H.C. Starck under the trade name Levasil®.

The inorganic particles preferably have a weight average particle diameter of less than 200 nm, in particular less than 150 nm, particularly preferably less than 120 nm and very particularly preferably less than 80 nm; the weight average particle diameter is preferably greater than 2 nm and in particular greater than 5 nm, particularly preferably greater than 10 nm and in particular greater than 20 nm.

The content of the inorganic particles in the aqueous polymer dispersion is preferably from 0.1 to 30 parts by weight.

The content is particularly preferably at least 0.5 part by weight and very particularly preferably at least 1 part by weight of the inorganic particles per 100 parts by weight of emulsion polymer.

The content is particularly preferably not more than 20 parts by weight and very particularly preferably not more than 15 or 10 parts by weight of the inorganic particles per 100 parts by weight of emulsion polymer.

### Regarding the Preparation Process

The aqueous polymer dispersion according to the invention is prepared by emulsion polymerization.

In the emulsion polymerization, ionic and/or nonionic emulsifiers and/or protective colloids or stabilizers are used as surface-active compounds.

The surface-active substance is usually used in amounts of from 0.1 to 10% by weight, based on the monomers to be polymerized.

Water-soluble initiators for the emulsion polymerization are, for example, ammonium and alkali metal salts of peroxodisulfuric acid, e.g. sodium peroxodisulfate, hydrogen peroxide or organic peroxides, e.g. tert-butyl hydroperoxide.

So-called reduction-oxidation (redox) initiator systems are also suitable.

The amount of initiators is in general from 0.1 to 10% by weight, preferably from 0.5 to 5% by weight, based on the monomers to be polymerized. It is also possible to use a plurality of different initiators in the emulsion polymerization.

Regulators may be used in the polymerization, for example in amounts of from 0 to 3 parts by weight, based on 100 parts by weight of the monomers to be polymerized, by means of which the molar mass is reduced. For example, compounds having a thiol group, such as tert-butyl mercaptan, ethylacryloyl thioglycolate, mercaptoethynol, mercaptopropyltrimethoxysilane or tert-dodecyl mercaptan, and regulators without the thiol group, in particular, for example, terpinolene, are suitable.

The emulsion polymerization is effected as a rule at from 30 to 130° C., preferably from 50 to 100° C. The polymerization medium may consist either only of water or of mixtures of water and liquids miscible therewith, such as methanol. Preferably, only water is used. The emulsion polymerization can be carried out either as a batch process or in the form of a feed process, including step or gradient procedure. The feed process in which a part of the polymerization batch is initially taken, heated to the polymerization temperature, and prepolymerized and the remainder of the polymerization batch is then fed to the polymerization zone, continuously, stepwise or with superposition of a concentration gradient while maintaining the polymerization, usually via a plurality of spatially separate feeds, one or more of which comprise the monomers in pure or in emulsified form. In the polymerization, the polymer seed may also be initially taken, for example for better adjustment of the particle size.

The manner in which the initiator is added to the polymerization vessel in the course of the free radical aqueous emulsion polymerization is known to the average person skilled in the art. It can either be completely initially taken in the polymerization vessel or used continuously or stepwise at the rate of its consumption in the course of the free radical aqueous emulsion polymerization. Specifically, this depends on the chemical nature of the initiator system as well as on the polymerization temperature. Preferably, a part is initially taken and the remainder is fed to the polymerization zone at the rate of consumption.

The individual components (e.g. monomers or initiators) can be added to the reactor in the feed process from above, at the side or from below through the reactor bottom.

For removing the residual monomers, initiator is usually also added after the end of the actual emulsion polymerization, i.e. after a monomer conversion of at least 95%.

According to the invention, the aqueous polymer dispersion is obtainable by emulsion polymerization of monomers in the presence of inorganic polymer particles (inorganic particles for short) which are dispersible in the aqueous phase without surface-active assistants. Preferably, the inorganic particles are dispersed in the aqueous phase without surface-active assistants.

Accordingly, the emulsion polymerization of the monomers is preferably carried out in the presence of the (in)organic particles. The inorganic particles may already be initially taken in the polymerization batch before the beginning of the emulsion polymerization or may be added during the emulsion polymerization. The addition of the inorganic particles can be effected continuously over the total duration of polymerization or over a limited time interval. The inorganic particles can also be added during the emulsion polymerization in one or more batches.

Preferably, the aqueous phase in which the emulsion polymerization is carried out comprises more than 50% by weight of the inorganic particles, particularly preferably more than 70% by weight, very particularly preferably more than 80% by weight and in particular more than 90% by weight of the inorganic particles before 90% by weight of all monomers which form the emulsion polymer have polymerized.

A high solids content is possible by means of the process according to the invention.

In a preferred embodiment, the content of the emulsion polymer and of the inorganic particles in the aqueous polymer dispersion (solids content) is altogether at least 50% by weight, in particular at least 55% by weight and very particularly preferably at least 60% by weight, or at least 65% by weight, based on the aqueous polymer dispersion.

### Regarding the Paper Coating Slip

The aqueous polymer dispersion is suitable as a binder, in particular as a binder in paper coating slips.

Paper coating slips comprise in particular as constituents
a) binder
b) if appropriate, a thickener
c) if appropriate, a fluorescent or phosphorescent dye, in particular as an optical brightener
d) pigments
e) further assistants, e.g. leveling aids or other dyes.

The above aqueous polymer dispersion which comprises the emulsion polymer and the inorganic particles is used as a binder. Further binders, for example including natural polymers, such as starch, can be concomitantly used. The proportion of the above aqueous polymer dispersion (calculated as solid, i.e. emulsion polymer and inorganic particles, without water) is preferably at least 50% by weight, particularly preferably at least 70% by weight, very particularly preferably 100% by weight, based on the total amount of binder.

The paper coating slips comprise binder preferably in amounts of from 1 to 50 parts by weight, particularly preferably from 5 to 20 parts by weight, of binder, based on 100 parts by weight of pigment.

Suitable thickeners b) are synthetic polymers, in particular celluloses, preferably carboxymethylcellulose.

Here, the term pigment d) is understood as meaning inorganic solids. These solids, being pigments, are responsible for the color of the paper coating slip (in particular white) and/or have only the function of an inert filler. The pigment comprises in general white pigments, e.g. barium sulfate, calcium carbonate, calcium sulfoaluminate, kaolin, talc, titanium dioxide, zinc oxide, chalk or coating clay or silicates.

The paper coating slip can be prepared by customary methods.

The paper coating slips according to the invention have a low viscosity and are very suitable for the coating of, for example, base paper or cardboard. The coating and subsequent drying can be effected by customary methods. The coated papers or cardboards have good performance characteristics; in particular, they are also readily printable in the known printing processes, such as flexographic, letterpress, gravure or offset printing. Particularly in the offset process, they result in high pick resistance and fast and good ink and water acceptance. The papers coated with the paper coating slips can be readily used in all printing processes, in particular in the offset process.

### EXAMPLES

### General

The Brookfield viscosity was measured at 100 rpm and is stated in mPa·s. The silica sol used was Levasil® 200A/30 from H.C. Starck (200 indicates the specific surface area (square meters per gram) and 30 indicates the concentration in water).

### Preparation of the Concentrated Copolymer Dispersions

Copolymer Dispersion D1 (with Silica Sol)

220 g of demineralized water and 70 g of a 33% strength by weight polystyrene seed (particle size 30 nm, with 16 parts by weight of emulsifier Disponil LDPS 20) and in each case 4% by weight of feeds 1A and 1B were initially taken at room temperature and under a nitrogen atmosphere in a 6 l pressure reactor equipped with an MIG stirrer and 3 metering apparatuses. Thereafter, the reactor content was heated to 90° C. with stirring (180 rpm) and, on reaching 85° C., 66 g of a 7% strength by weight aqueous sodium persulfate solution were added. After 10 minutes, beginning at the same time, the total amount of feed 1A and feed 1B was metered in continuously in the course of 240 minutes and feed 2 in the course of 270 minutes at constant flow rates. Over the total metering time, the flow rates of feed 1A and feed 1B were homogenized shortly before the entrance into the reactor. Thereafter, the reactor content was allowed to continue reacting for a further hour at 90° C. Thereafter, the reactor content was cooled to room temperature and the pressure container was let down to atmospheric pressure. The coagulum formed was separated from the dispersion by filtration over a sieve (mesh size 100 microns).

After measurement of the viscosity (see below), a pH of 6.5 was established with a 25% strength by weight aqueous ammonia solution and a solids content of 56.5% was established with demineralized water.

Feed 1A
homogeneous mixture of

| | | |
|---|---|---|
| 722 | g | of demineralized water |
| 61 | g | of a 15% strength by weight aqueous sodium dodecyl sulfate |
| | | solution |
| 26 | g | of Dowfax 2A1 from Dow Chemicals (45% strength by |
| | | weight) |
| 92 | g | of acrylic acid |
| 767 | g | of Levasil 200A/30 from H.C.Starck (silica sol, 30% strength |
| | | by weight) |

Feed 1B
homogeneous mixture of

| | | |
|---|---|---|
| 1426 | g | of styrene |
| 28 | g | of tert-dodecyl mercaptan |
| 782 | g | of butadiene |

Feed 2

| | | |
|---|---|---|
| 263 | g | of a 7% strength by weight aqueous sodium persulfate |
| | | solution |

The aqueous copolymer dispersion D1 obtained had a solids content of 56.5% by weight, based on the total weight of the aqueous dispersion. The glass transition temperature was determined as 12° C. and the particle size as 154 nm. The viscosities before/after neutralization are shown in table 1.

### Comparative Dispersion CD

220 g of demineralized water and 70 g of a 33% strength by weight polystyrene seed (particle size 30 nm, with 16 parts by weight of emulsifier Disponil LDPS 20) and in each case 4% by weight of feeds 1A and 1B were initially taken at room temperature and under a nitrogen atmosphere in a 6 l pressure reactor equipped with an MIG stirrer and 3 metering apparatuses. Thereafter, the reactor content was heated to 90° C. with stirring (180 rpm) and, on reaching 85° C., 66 g of a 7% strength by weight aqueous sodium persulfate solution were added. After 10 minutes, beginning at the same time, the total amount of feed 1A and feed 1B was metered in continuously in the course of 240 minutes and feed 2 in the course of 270 minutes at constant flow rates. Over the total metering time, the flow rates of feed 1A and feed 1B were homogenized shortly before the entrance into the reactor. Thereafter, the reactor content was allowed to continue reacting for a further hour at 90° C. Thereafter, the reactor content was cooled to room temperature and the pressure container was let down to atmospheric pressure. The coagulum formed was separated from the dispersion by filtration over a sieve (mesh size 100 microns).

After measurement of the viscosity (see below), a pH of 6.5 was established with a 25% strength by weight aqueous ammonia solution and a solids content of 56.5% was established with demineralized water.

Feed 1A
homogeneous mixture of

| | | |
|---|---|---|
| 1093 | g | of demineralized water |
| 61 | g | of a 15% strength by weight aqueous |
| | | sodium dodecylsulfate solution |
| 26 | g | of Dowfax 2A1 from Dow Chemicals |
| | | (45% strength by weight) |
| 92 | g | of acrylic acid |

Feed 1B
homogeneous mixture of

| | | |
|---|---|---|
| 1426 | g | of styrene |
| 28 | g | of tert-dodecyl mercaptan |
| 782 | g | of butadiene |

Feed 2

| | | |
|---|---|---|
| 263 | g | of a 7% strength by weight aqueous |
| | | sodium persulfate solution |

The aqueous copolymer dispersion CD obtained had a solids content of 56.5% by weight, based on the total weight of the aqueous dispersion. The glass transition temperature was determined as 13° C. and the particle size as 159 nm. The viscosities before/after neutralization are shown in table 1.

The solids contents were determined by drying a defined amount of the respective aqueous copolymer dispersion (about 5 g) at 140° C. to constant weight in a drying oven. In each case two separate measurements were carried out. The values stated in the examples are the mean value of these two measured results.

The glass transition temperature was determined according to DIN 53765 by means of a DSC820 apparatus, series TA8000, from Mettler-Toledo Int. Inc.

The mean particle diameter of the polymer particles was determined by dynamic light scattering on a 0.005 to 0.01% strength by weight aqueous polymer dispersion at 23° C. by means of an Autosizer IIC from Malvern Instruments, England. The cumulant z-average diameter of the measured autocorrelation function is stated (ISO standard 13321).

The Brookfield viscosity was determined according to DIN EN ISO 2555 with spindle 3 at 20 and 100 rpm, 23° C., 60 sec.

The pH was determined according to DIN ISO 976. The viscosity was measured before and after the adjustment of the pH to 6.5.

TABLE 1

| | D1 | CD |
|---|---|---|
| Solids content [%] | 56.5 | 56.5 |
| pH | 6.5 | 6.5 |
| Particle size [nm] | 154 | 159 |
| Viscosity at 20 rpm before neutralization | 800 | 5250 |
| Viscosity at 100 rpm before neutralization | 350 | 2100 |
| Viscosity at 20 rpm after neutralization | 1050 | 5280 |
| Viscosity at 100 rpm after neutralization | 510 | 2150 |

### Preparation of Coating Slip

The corresponding amounts of the binder were added to an aqueous dispersion of pigments according to the formulation and were homogenized using a high-speed stirrer. In the same way, further prescribed starting materials are also incorporated. Expediently, synthetic cobinders or thickeners are added as the final component, the amount being chosen so that the desired viscosity is reached.

The viscosity is tested according to Brookfield, DIN EN ISO 2555, RTV at 100 rpm, 23° C., the spindle size according to the description depending on the viscosity present.

The coating slips were adjusted to pH 9 with 10% strength NaOH.

In the offset test, a coated paper strip is printed on several times at short time intervals using a Prüfbau printability tester (MZ II). After a few passes, picking occurs, resulting in dots and spots on the printed paper. The result is stated as the number of printing processes until the first occurrence of picking.

The water retention according to Gradek indicates how fast a coating slip is dewatered. Rapid dewatering is equivalent to poor running properties on the coating machine. The coating slip is present at slight excess pressure (0.5 bar) in a pipe which is closed at the bottom by a polycarbonate membrane having a defined pore size (5 μm, diameter 47 mm). The water penetrating is taken up by filter paper. The less water released, the better is the water retention and the better are the running properties of the coating slip. The amount of water is stated in grams/square meter.

The high shear viscosity is tested using rotational viscometers (in this case rotational viscometer Rheostress 600 from ThermoHaake). A low high-shear viscosity is equivalent to good running properties and high machine speeds (high shear rates at the blade), and the viscosity is stated in mPa·s.

TABLE 2
results

| | | | | | Coating slip |
|---|---|---|---|---|---|
| | | | Coating slip | Coating | based |
| | | | based | slip based | on |
| | Solids content | Viscosity of | on D1 | on CD | Styronal |
| | of the starting | the starting | (parts by | (parts by | (parts by |
| | materials (% | materials | weight, | weight, | weight, |
| | by weight) | (mPa · s) | solid) | solid) | solid) |
| Hydrocarb 90 | 78.3 | | 70 | 70 | 70 |
| ME | | | | | |
| (calcium | | | | | |
| carbonate) | | | | | |
| Amazon 88 | 74.2 | | 30 | 30 | 30 |
| (clay pigment) | | | | | |
| D1 | 56.5 | 510 | 10 | | |
| CD | 56.5 | 2510 | | 10 | |
| Styronal ® D | 49.6 | 290 | | | 10 |
| 808 | | | | | |
| Sterocoll FS | 40 | | 0.1 | 0.1 | 0.1 |
| (thickener) | | | | | |
| Solids content | | | 70.6 | | 70.6 |
| of the coating | | | | | |
| slip (coating | | | | | |
| slips | | | | | |
| according to | | | | | |
| D1 and CD | | | | | |
| were diluted) | | | | | |
| Offset test | | | twice | — | twice |
| High-shear | | | 66.6 | | 74.9 |
| Viscosity | | | | | |
| Water | | | 90.6 | | 91.6 |
| retention | | | | | |

The coating slip based on CD could not be handled owing to the high viscosity.

1. An aqueous polymer dispersion obtainable by emulsion polymerization of monomers in the presence of dispersed inorganic polymer particles which are dispersible in the aqueous phase without surface-active assistants, the content of the emulsion polymer and of the dispersed inorganic particles in the aqueous dispersion being altogether at least 50% by weight.

2. The aqueous polymer dispersion according to claim 1, wherein the emulsion polymer obtained is composed of at least 40% by weight of monomers selected from the group consisting of C₁- to C₂₀-alkyl (meth)acrylates, vinyl esters of carboxylic acids having up to 20 carbon atoms, vinylaromatics having up to 20 carbon atoms, ethylenically unsaturated nitriles, vinyl halides, vinyl ethers of alcohols having 1 to 10 carbon atoms, aliphatic hydrocarbons having 2 to 8 carbon atoms and one or two double bonds and mixtures of these monomers.

3. The aqueous polymer dispersion according to claim 1, wherein the emulsion polymer is composed of at least 60% by weight of butadiene or mixtures of butadiene and styrene or at least 60% by weight of C₁- to C₂₀-alkyl (meth)acrylates or mixtures of C₁- to C₂₀-alkyl (meth)acrylates and styrene.

4. The aqueous polymer dispersion according to claim 1, wherein the emulsion polymer comprises at least 60% by weight of butadiene or mixtures of butadiene and styrene.

5. The aqueous polymer dispersion according to claim 1, wherein the inorganic particles are dispersed in a stable manner in water because of their content of hydrophilic groups.

6. The aqueous polymer dispersion according to claim 1, wherein the inorganic particles are silica sols.

7. The aqueous polymer dispersion according to claim 1, wherein the inorganic particles have a weight average particle diameter of less than 150 nm.

8. The aqueous polymer dispersion according to claim 1, wherein the aqueous polymer dispersion comprises from 0.1 to 30 parts by weight of the inorganic particles, based on 100 parts by weight of emulsion polymer.

9. The aqueous polymer dispersion according to claim 1, wherein the polymer dispersion is obtainable by virtue of the fact that the aqueous phase comprises more than 50% by weight of the inorganic particles before 90% by weight of all monomers which form the emulsion polymer have polymerized.

10. The aqueous polymer dispersion according to claim 1, wherein the polymer dispersion is obtainable by virtue of the fact that the aqueous phase comprises more than 80% by weight of the inorganic particles before 90% by weight of all monomers which form the emulsion polymer have polymerized.

11. A process for the preparation of aqueous polymer dispersions, comprising:
conducting emulsion polymerization in the presence of inorganic polymer particles which are dispersed in the aqueous phase without surface-active assistants, the content of the emulsion polymer and of the dispersed inorganic particles in the aqueous dispersion being altogether at least 50% by weight.

12. (canceled)

13. A paper coating slip comprising the aqueous polymer dispersion according to claim 1.

14. A paper or cardboard coated with the paper coating slip according to claim 13.

15. The aqueous polymer dispersion according to claim 5, wherein the hydrophilic groups are hydroxyl groups.

16. A method of forming a paper coating slip, comprising:
formulating said slip with components comprising the aqueous polymer dispersion of claim 1 as a binder.
